(19) United States
(12) Patent Application Publication
(10) Pub. No.: US 2005/0014581 A1
(43) Pub. Date: Jan. 20, 2005

(54) Infinitely adjustable cone pulley drive with torque sensor

(75) Inventor: Gert Schonnenbeck, Neu-Anspach (DE)

Correspondence Address: John S. Egbert;Harrison & Egbert, 7th Floor, 412 Main Street, Houston, TX, 77002, US

(73) Assignee: PIV Drives GmbH, Homburg (DE)

(21) Appl. No.: 10/889,460

(22) Filed: Jul. 12, 2004

(30) Foreign Application Priority Data
Jul. 11, 2003 (DE) 103 31 470.9

(51) Int. Cl. F16H 63/00; F16H 55/56

(52) U.S. Cl. 474/12; 474/18; 474/8; 474/15

(57) ABSTRACT

The invention relates to an infinite adjustable cone pulley drive with a torque sensor. In order to be able to produce these cone pulley drives in a more cost-effective and functional manner, according to the invention, roll bodies running on pressure curves and provided in the torque sensor for an axial force generation and axial adjustment are proposed.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to an infinitely adjustable cone pulley drive with two cone pulleys each arranged on the drive and output shaft and transmission means turning between them, a cone pulley being axially movable on each shaft by means of a pressure cylinder turning with the shaft, while the two other cone pulleys are axially stationary. At least one of the axially stationary cone pulleys is thereby allocated to a sensor for the transmitted torque for the load-dependent generation of contact forces. A pressure medium is supplied to it with the pressure prevailing on its own shaft or the other shaft in the pressure cylinder. Moreover, the sensor thereby has at least one roll body which is situated between two opposite pressure curves, one of which is allocated to the axially stationary cone pulley. The other pressure curve is allocated to an axially adjustable part of a cylinder/piston unit situated on the shaft.

### BACKGROUND OF THE INVENTION

An infinitely adjustable cone pulley drive of this type is known, for example, from DE-A 28 46 580.

In a device of this type, the torque is transmitted from the drive-pulley driveset to the output pulley set so as to be in frictional contact, whereby the contact pressure of the pulleys on the transmitting medium in the form of a chain rotating between the pulley drivesets is built up by oil pressure in the pressure cylinders. It is known to regulate the contact pressures of the pulleys in dependency on the transmitted torque for good efficiency and for as little wear on the chain and pulleys as possible for which the aforementioned torque sensor is used, said torque sensor is preferably located directly in the magnetic flux of the drive-pulley set.

The torque is thereby transmitted by an axially adjustable part of the cylinder/piston unit of the torque sensor to roll bodies which are usually formed by several balls. These balls convey the torque to a sensor plate which, as is known, is to be integrated in the axially stationary cone pulley. In this case, the roll bodies sit in ball pockets which are provided on the axially adjustable part and on the sensor plate and which have pressure curves in the form of inclined surfaces opposite one another in peripheral direction. As a result, axial force proportional to the torque builds up which presses the adjustable part of the cylinder/piston unit of the torque sensor against the oil within the cylinder/piston unit. At the same time, an outlet opening for the oil flowing through the cylinder/piston unit is adjusted by the axial adjustment of the adjustable part of the cylinder/piston unit. The oil is thereby throttled to such an extent that a balance sets in between the hydraulic force from the oil pressure of the cylinder/piston unit and the axial force generated by the roll bodies. As a result, the pressure within the system can follow a changing torque within only a few milliseconds and thus, in particular, more quickly than e.g. an automatic control system consisting of torque meter, regulator and proportional solenoid valve.

Moreover, a torque sensor of this type also functions as a very quick acting storage: In this connection, it must be taken into consideration that, when there is a sudden torque peak, the pressures in the pulley drivesets must increase quickly to prevent a harmful chain slip. From this point of view, the torque sensor is capable, as described above, of conveying stored oil for balancing the oil compressibility and system elasticity directly into the pressure cylinder allocated to the pulley sets, as a result of which it can temporarily replace a pump with a high capacity of, for example, more than 30 l/min. In addition, the torque sensor acts as a torsional-vibration balancer.

It is now the object of the invention to further develop a known device of this type so that it can even more quickly and dynamically follow the ensuing torque changes. Furthermore, the reaction force present in any case on the stationary pulley should be used to minimize deformation which is detrimental to efficiency.

### BRIEF SUMMARY OF THE INVENTION

According to the invention, this object is solved in that the roll body or bodies provided roll off on an effective radius which is at least as large as the outer radius of the piston of the cylinder/piston unit.

Thus, the invention is based on the realization that, in constructions used to date, the intrinsic elasticity of individual components as well as relatively high inert masses are detrimental to a high dynamic during readjustment of torque changes. This is minimized by the structural embodiment now proposed.

In particular, it is proposed that the pressure curves for the roll bodies at the axially stationary cone pulley are placed on a ring rotating on it. It can thus be obtained that the stationary cone pulley becomes more rigid. This lowers the inherent elasticity of this structural part. Moreover, it can thus also be obtained that, even with only a small number of roll bodies distributed about the periphery, this does not result in an undesirable, damaging bearing surface waviness of the stationary cone pulley. On the one hand, a low number of roll bodies reduces the inert mass which benefits the dynamics of the readjustment. On the other hand, however, fewer pressure curves which are expensive to manufacture are required.

Preferably, the rotating ring provided on the axially stationary cone pulley is made in one piece with said cone pulley. As a result, in particular, an even more cost-efficient production can be obtained.

In particular, in the device according to the invention, it is proposed to provide the cylinder as adjustable part in the cylinder/piston unit of the torque sensor, the effective radius of the roll bodies then having a size which is between the inner and outer radius of the cylinder. As a result, it is obtained that regulating forces produced by the roll bodies on the cylinder/piston unit act essentially in axial direction on the cylinder walls. These have a high rigidity in this direction, so that any structural elasticities that might occur are minimized and cannot negatively effect the dynamic behavior of the torque sensor nor produce any deformation of the stationary pulley.

### BRIEF DESCRIPTION OF THE SEVERAL VIEWS OF THE DRAWINGS

Further advantages and features of the invention can be found in the following description of an embodiment, showing:

FIG. 1 the schematic structure of a pulley driveset of a hydraulically adjustable cone pulley drive with a torque sensor.

### DETAILED DESCRIPTION OF THE INVENTION

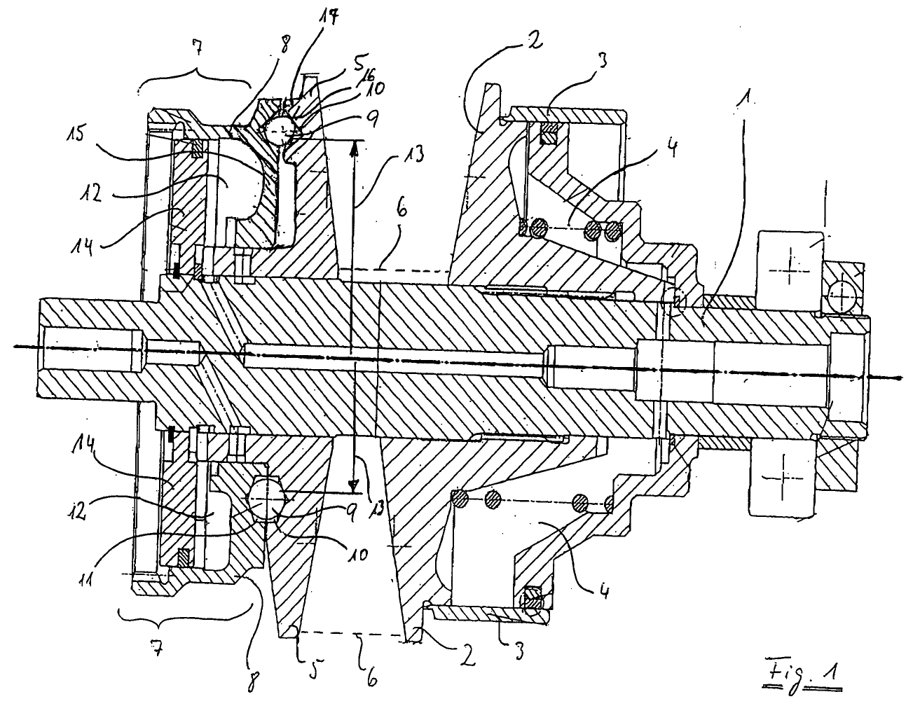

FIG. 1 shows the basic representation of a pulley set for a cone pulley drive. The prior art is shown below the center line. A further development according to the invention is shown above the center line.

The pulley driveset is situated on a shaft 1 on which an axially movable cone pulley 2 is arranged for adjusting and maintaining the desired gear ratio, said cone pulley 2 forming the cylinder of a cylinder/piston unit 4 with a rotating apron 3 connected with it.

A stationary cone pulley 5 is opposite the axially adjustable cone pulley 2. A chain 6 (not shown in greater detail) runs between the respective cone pulley pairs as rotating transmission means.

A pressure medium is supplied from a pressure medium source (not shown) to the cylinder/piston unit 4.

Moreover, a torque sensor 7 which determines the pressure in the cylinder/piston unit 4 sits on the shaft 1. Pressure oil flowing from the torque sensor can be delivered without pressure to the transmission means 6 to oil and cool it.

It is basically known that a drive which is set to a specific gear ratio slips through on the output side during a torque thrust on the drive shaft, which has a decidedly damaging effect. To counteract this, the torque sensor is located directly in the magnetic flux, preferably of the drive pulley set. The transmitted torque is transmitted by the movable cylinder 8 of the torque sensor 7 in the form of a cylinder/piston unit to several roll bodies 9 which are arranged between the cylinder 8 and the cone pulley 5. In the example shown here, the roll bodies are balls. However, in principle, roll-shaped or barrel-shaped roll bodies are also feasible.

The roll bodies 9 run in pockets 10, 11 which are worked into the cone pulley 5 or into the cylinder 8 of the torque sensor 7. These pockets have surfaces inclined in peripheral direction in this case. As a result, an axial force proportional to the torque builds up, said axial force pressing against the oil in the chamber 12 of the torque sensor 7 via the cylinder 8. When there is a sudden torque thrust, the oil discharge from the chamber 12 is sealed by shifting the cylinder 8 and thus the cylinder bottom 15 and, at the same time, the oil in the chamber 12 is pumped to a corresponding pressure increase at a high speed in the cylinder/piston unit 4 of the axially adjustable cone pulley to there produce the corresponding increase in pressure which prevents a damaging slip-through of the chain.

While the roll bodies 9 rotated on an effective radius 13 which is smaller than the outer radius of the piston 14 of the cylinder/piston unit forming the torque sensor 7 in the prior art, according to the invention, it is now proposed to select this effective radius at least as large as the radius of this piston 14, or larger. As a result, it can be obtained that the axial forces exerted by the roll bodies 9 on the cylinder 8 can be conveyed directly and without deviation into the cylinder wall and thus no elasticities of the cylinder bottom 15 result in a dynamic deterioration when the sensor is regulated. otherwise, this cylinder bottom 15 can also be designed thinner than in the previous prior art, which can also result in a saving in weight which in turn also results in a cost saving due to a saving in material, In addition, inert masses are again reduced.

As can be seen in FIG. 1, the pockets 10 with their contact curves 16 are provided in a ring 17 arranged on the cone pulley 5 in the embodiment according to the invention. This ring acts in a reinforcing manner on this cone pulley 5, so that it can also be made thinner. Furthermore, this ring makes it possible to provide fewer roll bodies distributed about the periphery, without the result that this smaller number of roll bodies and pockets in which they run resulting in a waviness of the bearing surface in the cone pulley 5.

Thus, on the whole, the invention makes it possible to improve the functionality of an infinite drive and at the same time obtain a more cost-efficient production.

1. An infinite adjustable cone pulley comprises:
two cone pulleys, each pulley arranged on a drive and output shaft with a transmission means turning therebetween; wherein a cone pulley is axially movable on each shaft, while the two other cone pulleys are axially stationary, wherein at least one of the axially stationary cone pulleys is allocated to a sensor for transmitted torque for load-dependent generation of contact forces, the sensor having at least one roll body and being situated between two opposite pressure curves, one one curve being allocated to an axially stationary cone pulley and the other curve to an axially adjustable part of a cylinder/piston unit of the sensor on the shaft; and wherein said roll body rolls off an effective radius which is at least as large as the outer radius of the piston of the cylinder/piston unit.

2. The cone according to claim 1, wherein the pressure curve is situated on the axially stationary cone pulley on a ring rotating thereupon.

3. The cone according to claim 2, wherein the ring is formed of one piece with the cone pulley.

4. The cone according to claim 1, wherein the cylinder is an adjustable part of the cylinder/piston unit, and wherein the effective radius has a size between the inner and the outer radius of said cylinder.
